(19) United States
(12) Patent Application Publication
(10) Pub. No.: US 2026/0094337 A1
(43) Pub. Date: Apr. 2, 2026

(54) PERSONALIZED DIGITAL HUMANS

(71) Applicant: Adeia Guides Inc., San Jose, CA (US)

(72) Inventors: Dhananjay Lal, Englewood, CO (US); Aldis Sipolins, Somerville, MA (US); Reda Harb, Saint Petersburg, FL (US)

(21) Appl. No.: 18/901,362

(22) Filed: Sep. 30, 2024

(51) Int. Cl. G06T 13/40

(52) U.S. Cl. CPC G06T 13/40; G06T 2200/24

(57) ABSTRACT

A virtual assistant entity with a human-like appearance may be generated for a current online interaction based on a human-based assistant used in a prior interaction associated with the user profile. When a likelihood of a request for the virtual assistant is determined in the current user interaction, the template of the virtual assistant may be pre-cached. A user satisfaction level indicated in user response data for the prior online interaction may be checked to determine whether it exceeds a predetermined satisfaction threshold. In response to a request for the virtual assistant entity, the current user interaction may be transitioned from a first mode, for example, a text message-based interaction with a chatbot, to a second mode with the virtual assistant entity with the human-like appearance. The assistant may be matched with the context or setting of the current online interaction.

### BACKGROUND

The present disclosure relates to the display of visual content and, more particularly, to generating virtual assistants or digital humans that are personalized or customized based on past interactions.

### SUMMARY

Virtual assistants that resemble humans in appearance or are human-like to some extent have become ubiquitous. Sometimes referred to as digital humans or avatars, virtual assistants may be generated to facilitate interactions with human users. For example, a website may provide information about a product, advice about a service, or a facility for handling a complaint using a virtual assistant to respond to the human. Often virtual assistants, sometimes known as digital assistants, are purpose-built for assisting humans with tasks such as learning a language, practicing for job interviews, rehearsing a presentation, providing financial or health tips, and the like. Chatbots are often replaced or supplemented by digital humans to deliver a more positive experience to users.

Digital human assistants are often styled to be representations of physical and behavioral traits that are desired by the humans. Traits such as attractiveness, trustworthiness, authority/dominance, responsiveness, submissiveness or the like are often thought to make the human user more amenable to receiving help by forming a positive first impression (physical traits) as well as continuing to be likeable (behavioral traits).

In some approaches, a system may generate a new appearance for a digital human for each session upon request. This may be inefficient in terms of computing resources and network traffic, as well as time consuming and latency-generating, especially when considering the scale of users accessing the digital human. On the other hand, an approach that uses the same digital human appearance for all user interactions would not be personalized based on the profile of the user.

A technological problem in designing the features, mannerisms, diction, or other aspects of the appearance and presentation of a virtual assistant and its behavior in the course of an interaction with a human has been to generate a virtual assistant that does not frighten the human, conveys a sense of authority and competence in speaking about a topic, gains the trust of the human, puts the human at ease, and more generally elicits in the human positive emotions about the interaction with the virtual assistant. This technological problem is exacerbated by the fact that individual humans respond differently from one another to a virtual assistant of the same appearance. Individual differences in perception of trustworthiness are shaped to a significant extent by personal experiences, as opposed to just be genetic factors. Individual social learning is often a key mechanism by which individual humans come to perceive who appears trustworthy. The kinds of appearance and other features in a virtual assistant that impart a feeling of trust, good feelings, and the like, are in part, learned based on an individual human's past experiences. In addition, the context or setting of a user interaction may drive the kind of virtual assistant that may be called for in view of the branding or public perception desired by the provider of the user interaction. A virtual assistant that is used for ticket sales to a rock concert may be unsuitable for a financial institution with a fiduciary duty of providing retirement planning.

A technological solution provided according to an aspect of the present disclosure is that previous interactions of a user with an online assistant, such as a human assistant or a virtual assistant, may be accessed, and the satisfaction of the user with the previous interaction may be determined. If the previous interaction was satisfactory to the user, then the system may access aspects of the appearance and other features of the human or virtual assistant of the previous interaction and use them to generate a virtual assistant to be used in a current or future interaction.

In some embodiments, the control circuitry may be further configured to determine an attribute of the context, such as the setting, theme, branding, level of formality, and the like, of the current user interaction and match the context, or the category of the context with a prior user interaction. For example, the appearance of the graphical representation or other attributes of the virtual assistant may be selected or otherwise generated by matching the current context with a prior user interaction. The context of the previous interaction may be appropriately translated, and a digital human model (2D or 3D) may be delivered by the platform of the current interaction. The system may select from virtual assistants so that the virtual assistant to be used may be animated using an AI model trained on behavioral traits that have also been mapped to the context. For instance, in view of the current context, the system may select a humorous avatar for display during playback of a comedic movie or scene and a sporty avatar for display during playback of sports-related content.

In some embodiments, the system may pre-cache a virtual assistant template based on the prior user interaction when the system determines that it is likely that a request for a virtual assistant may soon be received. For example, based on user frustration or lack of user satisfaction detected in a first mode or medium of user interaction (e.g., when the system detects a misunderstanding, repetition of messages, or lack of progress in a user text message exchange with a chatbot), a “schema” or template or file that stores some properties and attributes of the virtual assistant, or most or all of the attributes of the virtual assistant, may be pre-cached. Then, additional features of the virtual assistant may be selected or generated based on additional factors, such as the context of the current user interaction. The virtual assistant may be personalized based at least in part on one or more of: (i) a satisfaction level of the user with a virtual assistant, a human assistant or other human model with which the user has interacted; (ii) semantic features—a setting, issue or theme of the prior user interaction (e.g., customer needed help with fixing a bicycle, just like in the current user interaction) with a virtual assistant, a human assistant or other human model with which the user has interacted; (iii) physical or other traits (e.g., friendliness, trustworthiness, beauty, general appeal or the like) or personality type (e.g., Myers-Briggs, OCEAN model, or the like) of the virtual assistant, a human assistant or other human model with which the user has interacted.

Appearance, physical and other features, traits, including personality types and the like may sometimes be referred to herein as “features” or as “traits.” Features or traits of more than one virtual assistant or human from prior user interactions may be used to select or generate the virtual assistant for the current user interaction. The term digital human may mean a virtual assistant. The term virtual assistant may mean various types of computer-generated animation with whom a user interacts.

A method, system, non-transitory computer-readable medium, and means for implementing the method are disclosed for generating graphics. Such a method may include: determining, based on a current online interaction using a first mode and associated with a user profile, a likelihood of a request for a virtual assistant entity with a human-like appearance; accessing user activity data associated with the user profile, wherein the user activity data comprises a prior online interaction with a first online assistant entity with a human-based appearance; determining that user response data for the prior online interaction indicates a user satisfaction level that exceeds a predetermined satisfaction threshold; identifying at least one feature of the prior online assistant entity with the human-based appearance based at least in part on the determining that the user satisfaction level exceeds the predetermined satisfaction threshold; pre-caching the virtual assistant entity with the human-like appearance with at least the one identified feature of the prior online assistant entity with the human-based appearance; receiving, based on the current online interaction associated with the user profile, a request for the virtual assistant entity with the human-like appearance and a current context of the current online interaction; transitioning from the first mode of the current user interaction by generating an appearance of the virtual assistant entity with the human-like appearance, wherein the virtual assistant entity with the human-like appearance is based at least in part on the pre-cached virtual entity with the human-like appearance with the identified at least one feature of the first online assistant entity and a matching of the current context of the current online interaction with a prior context of the prior online interaction; and causing display of the generated virtual assistant entity.

For example, the prior online interaction may entail display of an image of a human agent responding via a network connection. The prior online interaction may be the user accessing or downloading content created by a content creator, or tuning in to a television show on a regular basis.

The user response may include one or more explicit responses—e.g., user indicates thumb up or thumb down, an emoji posted by the user, user responses in a survey about the interaction, and the like; monitoring the interaction—e.g., was the issue resolved, was a human agent required to ultimately resolve the issue, and the like; user sentiment monitoring and analysis—e.g., user voice or user tone detection, user facial expression or eye movement and the like; or may be based on a combination of two or more of the foregoing elements. The user satisfaction level with the prior online interaction may be determined in a variety of ways, for example, based on a length of the prior online interaction (e.g., a longer than average interaction due to system issues may sour the impression of the user toward the interaction and the entity with whom the user is interacting), a frequency of the prior user interaction, a regularity of the prior user interaction, a user-entered graphical user interface command (e.g., to make the content louder or to repeat it or parts of it) received during the prior online interaction, or a user rating received in response to the prior online interaction. The user satisfaction level with the prior online interaction may be determined based at least in part on user eye movement during the prior online interaction, user facial expression during the prior online interaction, user pupil dilation during the prior online user interaction, user verbal tone during the prior online user interaction, or user sentiment recognized during the prior online user interaction.

The feature of the prior online assistant entity with the human-based appearance may include, for example, gender, facial feature points, hair type, color of hair, color of skin, color of eyes, shape of eyes, or shape of mouth. The feature may include personality traits, including mannerisms, affectations, catch phrases, verbal or physical tics, and the like. In some embodiments, such features and other features may be captured and stored, for example, as a 3D volumetric or light-field model of the human, or as a 2D image of the human, or of the virtual assistant. The model may be derived from a single camera or multi-camera image capture using volumetric or light-field capture techniques.

The system may match the current context of the current online interaction with the prior context of the prior online interaction by determining a first context category of the first context of the prior online user interaction; determining a second context category of the current context of the current online interaction; and determining that the first context category is a same as the second context category. The context may also include semantic context, for example, the similarity of the types of terms used in the user interactions, the themes discussed, the people or places discussed, and the like.

The system may also identify a personality trait of the first online assistant entity with a human-based appearance, and generate the virtual assistant entity with the human-like appearance based at least in part on the personality trait of the first online assistant entity with the human-based appearance. The generating of the appearance of the virtual assistant entity with the human-like appearance may include adapting a stored digital human model, wherein the adapting is based at least in part on the identified at least one feature of the first online assistant entity with the human-based appearance.

Such a method may also include determining that second user response data for the online interaction indicate a second user satisfaction level that exceeds the predetermined satisfaction threshold; identifying a second feature of the virtual assistant entity with the human-like appearance based at least in part on the determining that the second user response data for the virtual assistant interaction indicates that the second user satisfaction level exceeds the predetermined satisfaction threshold; receiving a second request for a second virtual assistant interaction associated with the user profile; generating an appearance of a second virtual assistant entity with a human-like appearance based at least in part on the identified second feature of the virtual assistant entity with the human-like appearance; and causing display of the appearance of the second virtual assistant entity with the human-like appearance generated for the request for the second virtual assistant interaction. For example, according to this aspect of the method, the generating the appearance of the second virtual assistant entity based at least in part on the identified second feature of the virtual assistant entity may entail generating the appearance of the second virtual assistant entity based at least in part on the identified feature of the virtual assistant entity.

The system may identify a second feature of the first online assistant entity with the human-based appearance, such that the generating the appearance of the virtual assistant entity with a human-like appearance is based at least in part on the identified second feature; identify the second feature of the virtual assistant entity with the human-like appearance based at least in part on determining that second response data for virtual assistant interaction indicates that a second user satisfaction level exceeds the predetermined satisfaction threshold; determine that the second user satisfaction level exceeds the user satisfaction level indicated by the user response data for the first online interaction; receive a request for a second virtual assistant interaction associated with the user profile; based at least in part on the determining that the second user satisfaction level exceeds the user satisfaction level indicated by the user response data for the first online interaction, generate an appearance of a second virtual assistant entity with a human-like appearance by replacing the second feature of the first online assistant entity with the identified second feature of the virtual assistant entity.

The request for the virtual assistant entity with the human-like appearance may be triggered based on content of the first mode (e.g., the system detects a lack of user satisfaction with the first mode) in the current online interaction. The first mode may be a text support mode.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1A illustrates an example of a virtual assistant generated for a user device for a user interaction based on a prior user interaction with a human, according to an example of an aspect of some embodiments of the present disclosure;

FIG. 1B illustrates an example of a virtual assistant generated for a user device for a user interaction based on a prior user interaction with a virtual assistant, according to an example of an aspect of some embodiments of the present disclosure;

FIG. 2 illustrates an example of several processes that may be involved in virtual assistant generation, in accordance with some embodiments of the disclosure;

FIG. 3 illustrates an example of processes that may be involved in virtual assistant pre-processing, feature extraction and generation, in accordance with some embodiments of the disclosure;

FIG. 4 illustrates an example of feature extraction and compilation, in accordance with some embodiments of the disclosure;

FIG. 5 illustrates an example of system interactions between a user device, a digital human generating platform and another node, such as a thirdparty, in accordance with some embodiments of the disclosure;

FIG. 6 illustrates an example of a digital human platform providing a humanized AI agent or other digital human for content from another server, such as the metaverse, in accordance with some embodiments of the disclosure;

FIG. 7 illustrates an example of system interactions for requesting and generating a virtual assistant, in accordance with some embodiments of the disclosure;

FIG. 8 illustrates a computer system for implementing methods described herein, according to an example of an aspect of some embodiments of the present disclosure;

FIGS. 9A and 9B contain a flowchart that illustrates a process for virtual assistant generation, according to an example of an aspect of some embodiments of the present disclosure; and

FIG. 10 is a flowchart that illustrates a process for virtual assistant selection and generation, according to an example of an aspect of some embodiments of the present disclosure.

The drawings are intended to depict only typical aspects of the subject matter disclosed herein, and therefore should not be considered as limiting the scope of the disclosure. Those skilled in the art will understand that the structures, systems, devices, and methods specifically described herein and illustrated in the accompanying drawings are non-limiting exemplary embodiments and that the scope of the present invention is defined solely by the claims.

### DETAILED DESCRIPTION

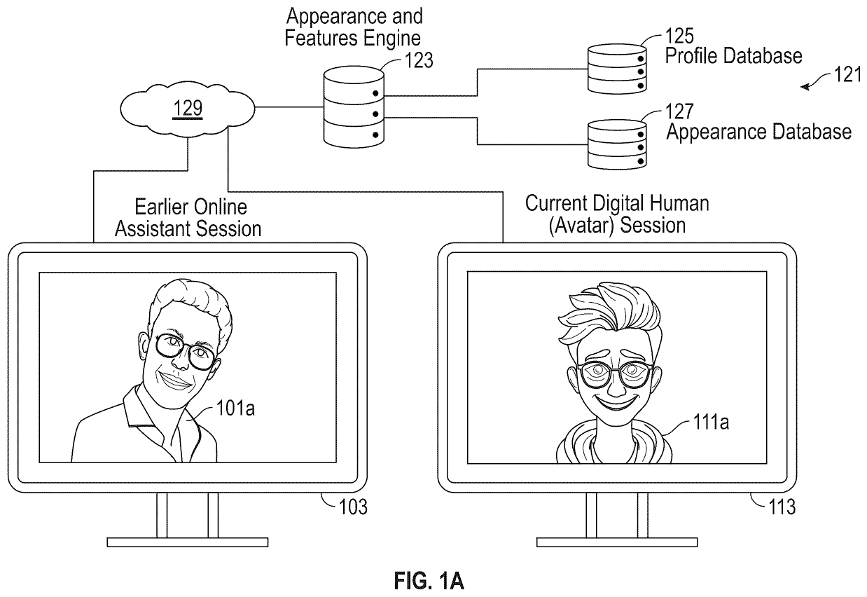

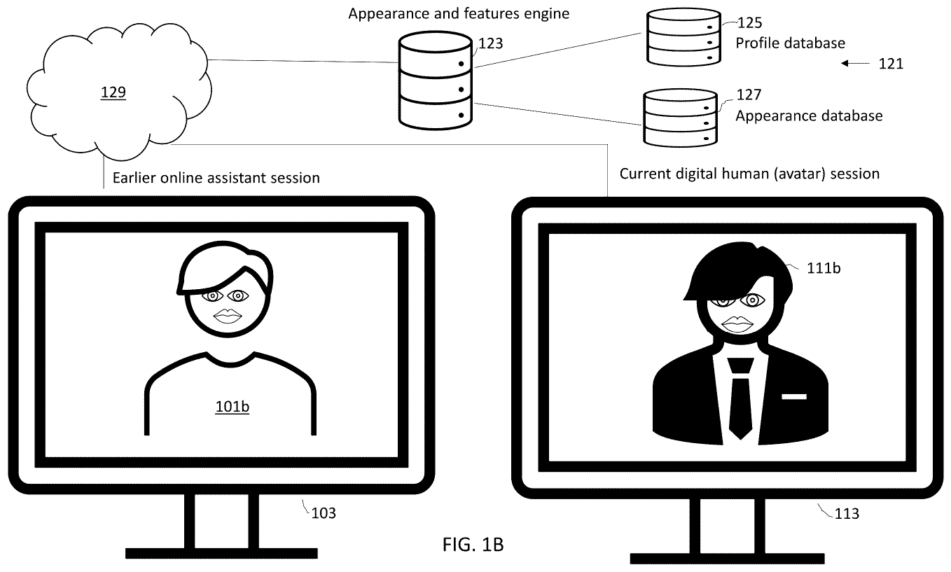

FIG. 1A illustrates an example of a scenario in which a system 121 generates a virtual assistant 111a with a graphically animated appearance or other attributes generated based on a human assistant 101a (sometimes referred to as a first online assistant entity with a human-based appearance) in a prior user interaction. A user may be interacting with the human assistant on a first device 103 and the user may be interacting with the virtual assistant on a second device 113, or the first device 103 and the second device 113 may the same device at subsequent user interactions. The system 121 may store in an appearance database 127 one or more aspects of the appearance of the human assistant 101a in the previous interaction and may store in a profile database 125 one or more other features of the human assistant 101a in the previous interaction. When a current or future user interaction with a virtual assistant 111a, 111b (sometimes referred to as virtual assistant entity with a human-like appearance) is needed (e.g., when the user interacts via a device 113 with an online environment in which a virtual assistant is called for), the system 121 may select or otherwise generate the virtual assistant 111 based on the appearance and features of the previous human assistant 101a.

By way of illustration, user Monica is looking for assistance from a business from which she purchased a new device. At this stage, Monica has been unable to operate the device and is unsure whether it works. When she reaches out to the business via the internet, she is assisted by a digital human. This may occur in a 2D environment over her desktop, or it may be in a 3D scene with six degrees of freedom (6DoF) in a virtual reality (VR) environment. The platform may reach out to a system that has a user profile about Monica, such as Google or Meta, and request a digital human model that is viewed as trustworthy by Monica.

Continuing with the example, Monica follows an influencer Alex, who gives advice on financial matters, and she trusts his advice. Or, Alex may be a character or real personality on media content she watches. Based on user interaction data from one or more sessions, such as how much time she has spent viewing or watching Alex, her comments, “likes,” recommendations to others, and the like, her user satisfaction with Alex may be evaluated. User interactions with specific media content item or social network feed creator or other content creator, webcaster, newscaster, celebrity, politician, financial pundit, or the like, may be a source of explicit or implicit indication of likes and dislikes, appeal or lack of appeal, satisfaction or lack of satisfaction. Armed with this user profile information, the digital human platform generates a digital human, “Adam,” with similar traits (glasses, hair et cetera) as Alex, to predispose Monica to trusting Adam. This digital human may then be provided as a model to an online platform, such as the server system of a business, to interact with Monica and assist her in operating the product. In the illustrative example, photorealism (or lack thereof) of the digital human may not be essential. The system may transform some attributes to remove exact or obvious likeness to a human or to a virtual assistant of the prior user interaction.

In some embodiments, the system may select the digital human model that is used as the virtual assistant for the current user interaction, or as a basis for personalizing or for generating the virtual assistant for the current user interaction, based on the virtual assistant with which the user had a high satisfaction level or the highest satisfaction level. For example, the system may compare two or more prior user interactions with different humans or with different virtual assistants associated with the user profile and may then select as the template for the virtual assistant for the current interaction features of the assistant associated with the user interaction with the higher or the highest user satisfaction.

In some embodiments, the system may select the digital human model based on a context or setting of the prior user interaction. For example, if the current user interaction for which a virtual assistant is requested is for a financial services website, then the system may search for a prior user interaction with a human or with a digital human model in the same or a similar industry. Or, the system may search for a prior user interaction with a human or with a digital human model in a setting that tends to call for trust, a fiduciary duty, or a seriousness of purpose. In an embodiment, the system may search for such a prior user interaction only after it first attempts and fails to find one in the same or a similar industry as that of the current interaction being requested.

One or more physical traits and/or one or more behavioral traits may be reconstructed or derived from stored or captured assistants associated with prior user interactions. The system may animate the virtual assistant, accordingly, with behavioral traits represented by an AI model. A machine learning (ML) model may enable perceiving and understanding complex actions of the human assistant or the virtual assistant of a prior user interaction, and then recreate a virtual assistant to perform accordingly. Generative physical AI extends current generative AI with understanding of spatial relationships and physical behavior of the 3D world we all live in. This may be done by providing additional data that contains information about the spatial relationships and physical rules of the real world during the AI training process. In some embodiments, semantic context may also be stored in the record. When a new semantic context is received in a request for a virtual assistant for a current user interaction, then it may be compared to stored semantic contexts and the closest stored semantic context is determined. This may be then converted to context, and further processed to deliver the digital human.

There may be a scenario in which the system must choose between: (i) selecting as a template a virtual assistant of a first prior user interaction in a context closer to the context of the current user interaction or the context category of the current user interaction, or (ii) selecting as a template a virtual assistant of a second prior user interaction with a higher satisfaction level than the first prior user interaction. In some embodiments, in such a scenario, the system would select one or more features of the first prior user interaction. In some embodiments, in such a scenario, the system would select one or more features of the second prior user interaction. In some embodiments, in such a scenario, the system would determine whether the satisfaction level of the second user interaction was higher than a first satisfaction threshold, in which case it would select the second user interaction. If the satisfaction level of the second user interaction was lower than a second satisfaction threshold, it would select the first user interaction (even though the satisfaction level of the second user interaction was higher than the satisfaction level of the first user interaction). In some embodiments, in such a scenario, the system would merge aspects of the assistants of the first and second user interactions by taking aspects of the first assistant (e.g., having to do with attire and other features more closely related to the context of the interaction) and aspects of the second assistant (e.g., features not directly related to the context of the interaction).

As shown in FIG. 1B, the system 121 may store in the appearance database 127 one or more aspects of the appearance and other properties of a virtual assistant 101b in the previous user interaction (sometimes referred to as a first online assistant entity with a human-based appearance, as a prior virtual assistant, or as a first online assistant entity with a human-like appearance). Based at least in part on one or more features and other properties of the virtual assistant 101b of the previous user interaction, the system may generate the virtual assistant 111b for the current user interaction.

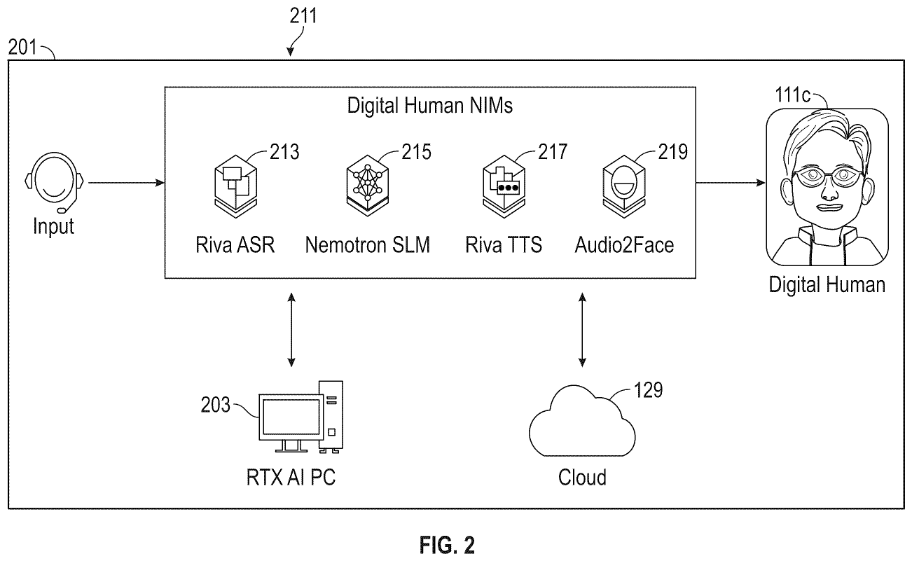

FIG. 2 illustrates an example of virtual assistant generation based on a prior user interaction with a prior virtual assistant.

An Automatic Speech Recognition (ASR) module 213 (this and some other modules illustrated, by way of example, as being of a specific brand) to which user input 201 provides speech data, a small language module (SLM) 215, a text-to-speech (TTS) module 217 and an audio to face (Audio2Face) module 219 may all be part of a virtual assistant engine 211 that generates virtual assistant 111c for interacting with a user via network such as the cloud 129.

The (ASR) may take an audio stream or data in an audio buffer as input and return one or more text transcripts, along with additional optional metadata. Speech recognition may entail a GPU-accelerated compute pipeline, with optimized performance and accuracy. Offline/batch and streaming recognition modes may each be provided. The text may then be fed to an SLM or to a large language model (LLM). An SLM may be used for user interactions of a specific setting and may be used even with less data than an LLM, which may be sufficient to deliver accurate responses with speed adequate for conversing with a human user in real time. Using an SLM, noncritical outputs may be pruned or removed to reduce the parameter size of the model.

The output produced by the SLM 215 (or an LLM) may be input to the TTS 217 pipeline. The TTS pipeline may entail first generating a spectrogram using a first model, and then generating speech using the second model. A spectrogram may be a representation of the spectrum of frequencies of a signal as it varies with time. Such a TTS pipeline may enable synthesis of natural sounding speech from raw transcripts without any additional information such as patterns or rhythms of speech.

The audio thus produced may be made to appear to emerge from the digital human 111c using computer facial animation, in this case illustrated by way of example as Audio2Face module 219. Audio2Face module 219 may use in real time the streamed audio generated by TTS 217 for lip-syncing and facial performances. For example, Audio2Face module 219 may be implemented using a machine learning (ML) model, e.g., using neural machine translation (NMT).

The context or setting of the current interaction may be used to select or to otherwise generate attributes of the virtual assistant 111 to be used. The system may operate in several modes:
provide personalization of only the physical appearance of the virtual assistant;
provide personalization of the physical appearance and of other features of the virtual assistant;
provide personalization of the language, dialect or pronunciation/diction/accent of the virtual assistant; and/or
provide personalization of the virtual assistant taking into account the context or setting of the interaction.

In some embodiments, machine learning models may be used to personalize the virtual assistant. For example, appearance and other aspects of the presentation of the virtual assistant, behavioral traits, personality traits and the like, or two or more of the following may be personalized using such models. In some embodiments, the context of the interaction may be taken into consideration to deliver a virtual assistant with behavioral traits appropriate to the situation (e.g., a digital medical information provider may have a different appearance, mannerisms, verbal tone, choice of words than an automobile repair information provider). An AI model may be trained in specific ways of generating movement/animation to a rigged character. Physical AI refers to models that understand and interact with the real world using motor skills, and they are often housed in autonomous machines, such as robots or self-driving vehicles. Generative physical AI extends current generative AI with understanding of spatial relationships and physical behavior of the 3D world. Data regarding the spatial relationships and physical rules of the real world may be used during the AI training process in the training process.

In some embodiments, personality traits may be used to personalize a virtual assistant for a specific user. Physical trait data of an online assistant captured from a prior interaction of the user may be converted to an apparent personality type for the virtual assistant to be generated. For example, this may be used when specific behavioral trait data is unavailable, or it may be used together with behavioral trait data for a more comprehensive approach. Inferring personality type of an online assistant from a prior interaction may be based on multimodal first impression data. Computer vision may be used to analyze human faces, body postures and behaviors to infer the perceived or apparent personality traits. One such approach is Automatic Personality Perception (APP), which maps prosodic aspects of speech into perceived personality traits that human listeners tend to attribute to the speaker. Unlike Automatic Personality Recognition (APR), the goal of APP is to predict the personality as per perceived by observers, not to predict the personality of an individual. Stated differently, APP is used to predict not the actual personality of a person, but the personality that others attribute to her/him in a given situation. Psychological scales may be used to establish various personality trait models For example, Big-Five model, also known as the OCEAN model, aims to measure a person's personality through five dipolar scales: openness (O), conscientiousness (C), extroversion (E), agreeableness (A), and neuroticism (N). Other such approaches include the Cattell sixteen personality factor (16PF) and the Myers-Briggs type indicators (MBTI).

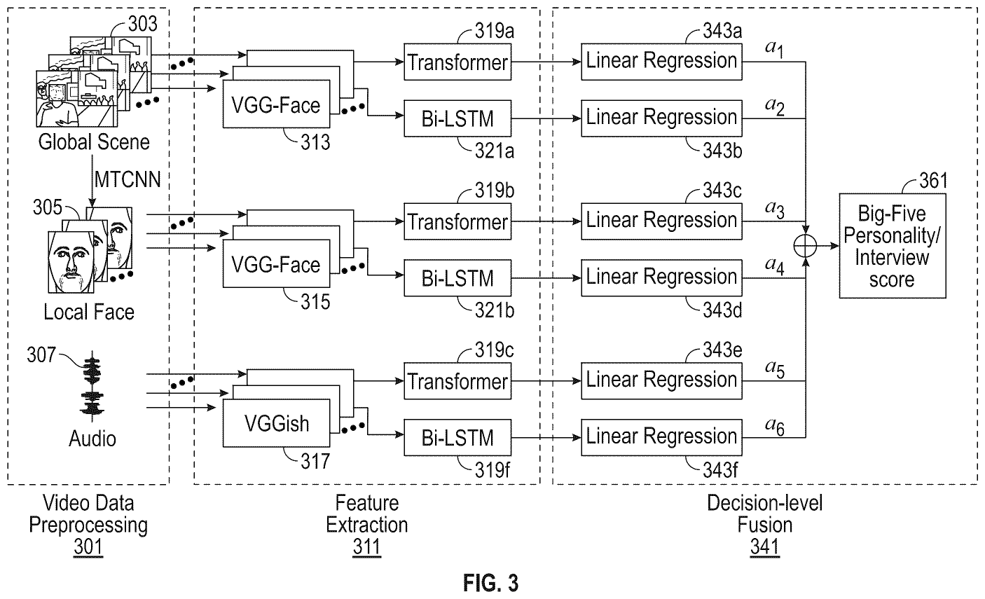

For example, the Big-Five Personality perception on the MBTI scale may use fuzzy logic to predict perceived multimodal personality traits, integrating audio-visual modalities based on a hybrid deep learning framework. In this approach, convolutional neural networks (CNN), bi-directional long short-term memory network (Bi-LSTM), and the Transformer network may be used. In particular, a pre-trained deep audio CNN model may be used to learn high-level segment-level audio features. A pre-trained deep face CNN model may separately learn high-level frame-level global scene features and local face features from each frame in dynamic video sequences. Then, these extracted deep audio-visual features may be fed into a Bi-LSTM and a Transformer network to individually capture long-term temporal dependency, thereby producing the final global audio and visual features for downstream tasks. Then, linear regression may be used to conduct the single audio-based and visual-based personality trait recognition tasks, followed by a decision-level fusion strategy used for producing the final Big-Five personality scores. FIG. 3 illustrates an example of such an approach.

As shown in FIG. 3, image data representing global scene 303 and image data 305 representing a face may be pre-processed at 301 and then fed for feature extraction processing 311. In particular, the image data representing global scene 303 and image data 305 representing the face may be processed using a deep learning classifier such as VGG (visual geometry group) 313, 315, a template matching technique for digital image processing to find small features or parts of an image that match a template image. A modified version 317 of this VGG approach may be used to process audio data 307 that may be received in conjunction with video data 303. The outputs of VGG-Face 313, VGG-Face 315, and VGGish-Face 317 may be provided, respectively, to the convolutional neural networks (CNN) bi-directional long short-term memory networks (Bi-LSTM) 321a, 321b, 321c, and to the transformer networks 319a, 319b, 319c. Following this, in a decision-level fusion process, linear regression 343a, 343b, 343c, 343d, 343e, 343f, may be used on the outputs, respectively, of the bi-directional long short-term memory networks (Bi-LSTMs) 321a, 321b, 321c, and the transformer networks 319a, 319b, 319c.

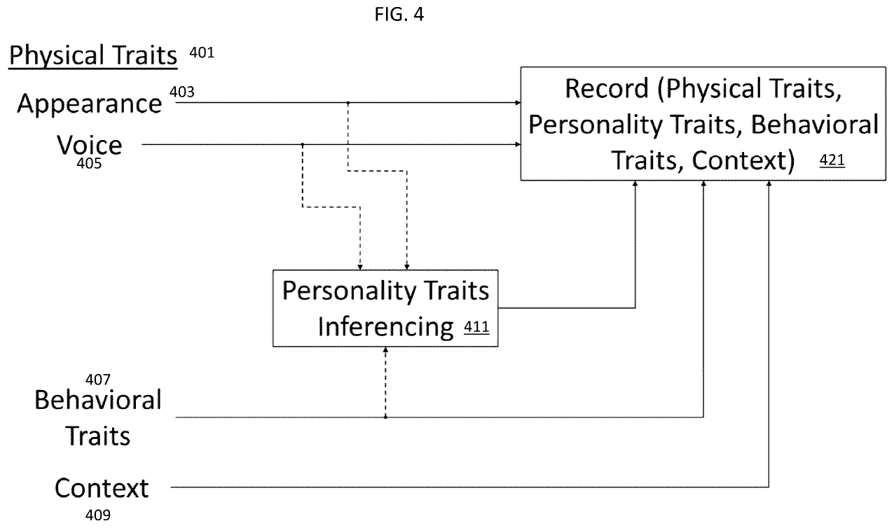

FIG. 4 illustrates an example of a process for detecting, inferring and recording various perceived traits of an assistant in a previous interaction. Physical traits 401 of an assistant in a previous user interaction, including appearance 403, voice features 405, behavioral traits 407 as well as the context 409 of the interaction with the assistant may be detected.

In addition, personality traits 411 of the assistant may be inferred based on the appearance 403, the voice 405 and the behavioral traits 407. As shown in FIG. 4, the behavioral traits and the words of the conversation captured may be used to infer one or more personality traits of the human assistant with whom the interaction occurred. When a query for a new interaction is received, the system may deliver a digital human model (both physical and behavioral traits) that maps well to the context. Each of the appearance 403, the voice 405, the behavioral traits 407, context 409 and personality traits 411 inferred may be recorded to a memory 421.

One or more personality traits, or a combination of some traits, for the virtual assistant may then be re-created using Generative AI, based on the inferred personality traits of the assistant in the previous interaction. For example, the Big Five personality traits may be re-created using ChatGPT. When the system receives a request to deliver a digital human for a context, the specific personality type may also be recreated by the system using an AI model to drive the conversational style deployed by the digital human.

In some embodiments, the semantic context may also be stored in the record. The semantic context may include the topic of conversation of the user interaction, the physical or geographic setting of the user interaction, the major issues discussed as part of the user interaction, the people or organizational entities involved in the user interaction, or the like. When a semantic context is determined in a request for virtual assistant, then it may be compared with stored semantic contexts and the closest stored semantic context may be selected.

In an embodiment, a digital human may be made to look more or less trustworthy according to externally provided input parameters. Based on physical and behavioral traits of humans extracted from interactions, the system may also derive attributes associated with untrustworthiness or other negative attributes. For example, a user may be interacting with a digital human shopping assistant to purchase a chair. The user asks the digital human to summarize the options, which include chair x and chair y. By default, the digital human shopping assistant would use the same behavioral and physical attributes when summarizing each option. Alternatively, physical and behavioral attributes of the virtual assistant may be modified based on a variety of parameters. For example: If an advertiser has spent money promoting chair x, the virtual assistant may appear less positive when describing chair y (or vice versa). If chair x has 10 reviews and chair y has 20 k reviews, the virtual assistant may appear more trustworthy when describing chair y (or vice versa).

In another example, a virtual assistant may appear skeptical or worried when asked to interact with a website or app with loose security protocols. For example, a digital human may be made available by a browser or browser-like entity to appear and to operate in the metaverse and to represent the user's interests. In such situations, the entity may represent the input received from a metaverse location/domain (akin to a website) using a digital human who appears skeptical, to signal to the user that the location/domain is not secure. Such transformation of the digital human may also be made based on user ratings, expert ratings, or government ratings of a metaverse property/internet domain and may be embedded in a root trust certificate.

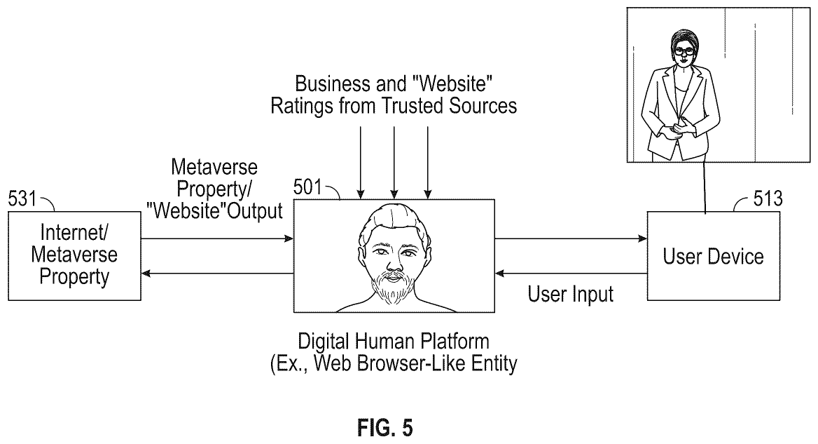

A virtual assistant may serve as an intermediary with internet or metaverse domains. As shown in FIG. 5, a user using a user device 513 may interact with a virtual assistant provided by a digital human platform 501. The virtual assistant may aid in finding resources on the internet, answer questions about various issues, and/or be an intermediary or an assistant in curating or facilitating access and navigation in a virtual reality environment or metaverse 531. The digital human platform 501 may rate sources or recommend businesses, organizations or other platforms to guide the user. As discussed above, a digital human may be made available by a browser or browser-like entity to appear in the metaverse to guide the user or to operate on behalf of the user.

In some embodiments, the digital human platform 501 may generate display of visual information to the user device 513 during the interaction to enhance the experience. In a traditional interaction with customer service, a human agent may share a screen from a customer service platform with the user, or may have to repeat information, such as a confirmation number, order number etc. However, a virtual assistant AI agent may invoke API-based commands based on the user interaction. The virtual assistant may not have a display screen of a customer service platform to enter information or take action to share with the user. Thus, the virtual assistant may synthesize the visual information for display to the user.

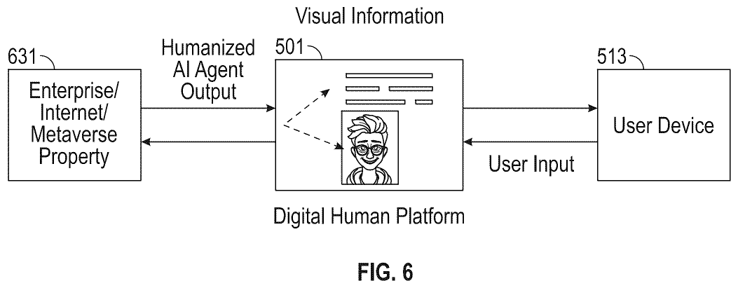

As shown in FIG. 6, the digital human platform 501 may generate a virtual assistant that provides information from a server 631, which may be part of a third party server. The user device 513 may then render information provided by the server 631 together with a display of the virtual assistant provided by the digital human platform 501.

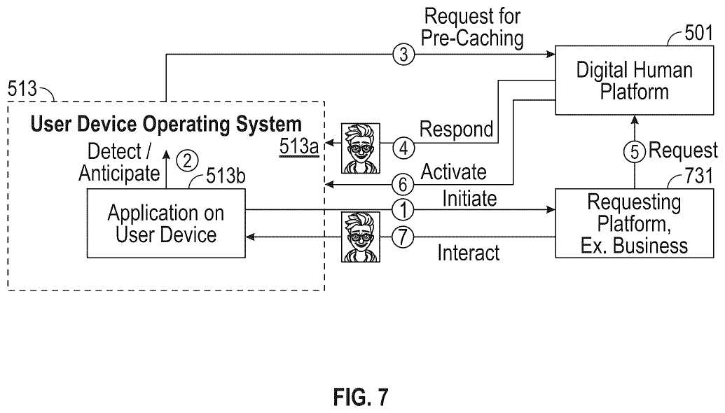

In some embodiments, the digital human platform 501 may receive a signal from an application or operating system on the user device 513 that indicates a likelihood that a virtual assistant may soon be needed, which may trigger digital human platform 501 to pre-cache a suitable virtual assistant. For example, as shown in FIG. 7, at 1, a user device 513 may transmit a text message to a telephone number for customer service platform 731 of a business. Based on this text message, at 2, the system may anticipate the need for a digital human and may interpret the semantic context. Other triggers for the pre-caching, such as user's voice/utterances or the like, may also be used. For example, the messaging platform 501 may detect frustration or repeating requests to a platform or application with which the human is communicating or attempting to communicate, or may detect a likely imminent need for user help or for a virtual assistance in other ways. Or, the user may have the option of engaging with a video-based digital assistant. Such an option may be available to the user immediately when starting a user interaction, or may become available to the user after the user interaction has dragged on for longer than an average time for this type of interaction or when user frustration is detected.

Based on such a detection, at 3, the operating system 513a may send a virtual assistant model for pre-caching to the user device 513. Some or all of the schema, template or file for the virtual assistant, or all or most of the data for the virtual assistant may be pre-cached at a server, for example, at digital human platform 501 or at requesting platform 731 that has requested the virtual assistant, or may be pre-cached at the user device 513. The operating system 513a may also provide a context/setting of the interaction to the digital human platform 501, or it may send the semantic context to the digital human platform 501. The digital human platform 501 may use the context of the interaction provided and subsequently, the digital human platform 501 may receive a request to provide the virtual assistant in preparation for transition to virtual assistant mode. In this way, support for the user interaction may be provided, or the level of support escalated, according to the support level needed. For example, the initial medium of communication and support with a website may be scrolling and looking for helpful information, or the initial medium of communication and support may be exchanging text messages with a virtual chat agent. In this way, real time rendering of the virtual assistant may be facilitated, and latency mitigated, for the current user interaction. Then, the user may be switched to a virtual assistant that is human-like, such as an animated virtual human generated as discussed, which may be rendered on the same user device or via a second user device, for example, on an extended reality (XR) head-mounted device (HMD). For example, a first user device may coordinate transition to the second user device. The system may detect the presence of a supported second user device such as XR equipment and allow the user to select it. For example, devices may be linked via a user account or user profile. Accordingly, the first user device may present the user an option such as “Launch Assistant on XR device.”

In some embodiments, the system may select for pre-caching features of the virtual assistant based on user satisfaction. For example, the system may compare two or more prior user interactions associated with the user profile and select as the template for the virtual assistant for the current interaction features of the assistant associated with the user interaction with the higher or highest user satisfaction. Then, before a request for a virtual assistant is received, the system may tailor the virtual assistant with additional features based on the context of the current user interaction. For example, if the current user interaction is with a website or virtual reality environment of a financial institution but the prior interaction was not with a financial institution, then the system may add features (e.g., attire, mannerisms, formality of speech, and the like) to reflect the current context of the current user interaction. The system may personalize the template by adding or substituting features after the initial template is pre-cached.

Continuing with FIG. 7, at 4, the digital human platform 501 may acknowledge the request and may commence generation of the virtual assistant based on the information it is provided. At 5, the digital human platform 501 may receive a request from a requesting platform 731 for the virtual assistant, and, at 6, the digital human platform 501 may transmit to the user device 513 a request to activate the virtual human earlier provided. Additional features of the virtual human may also be transmitted to the user device 513. In this manner, the system may speed up the delivery of the digital human by pre-caching and/or pre-loading the model. In an embodiment, the application 513b may anticipate this need, or a likelihood of such a need, or may detect triggers for a request for a virtual assistant.

Input parameters to control traits and other features of the virtual assistant may be associated with various digital human attributes such as speech patterns, body language, or physical appearance. In some embodiments, input parameters may be provided in the form of a simple value (e.g., trustworthiness=x) or as simple values combined with specific attributes (e.g., facial expression trustworthiness=y). In some embodiments, input parameters may be provided as a set of attribute combinations (e.g., facial expression trustworthiness=y, voice trustworthiness=a, body language trustworthiness=b).

In some embodiments, the system may use an “explore versus exploit” (EvE) reinforcement learning approach in determining traits or other features of the virtual assistant that are dominant in delivering a positive/negative or advanced context attribute experience to a specific user. EvE entails a balancing act between two opposing strategies: exploitation involves choosing an optimized option based on current knowledge of the traits and features for the virtual assistant, which may be incomplete or misleading based on prior user interactions.

Exploration involves trying out new options'traits and features whose relevance to this user or to this user interaction may be unknown or merely suggested based on prior user interactions, but use of them for the current virtual assistant being generated may lead to better outcomes in the future at the expense of an exploitation opportunity.

In some embodiments, the system may take into account that the user is multi-lingual. For example, the use of one or more languages and dialects by a user may be detected by the system (e.g., based on user profile data, based on one or more previous user interactions, based on other information stored in the user device 513) during the analysis phase. The system may then re-create a multi-lingual digital human model.

In some embodiments, the digital human platform 501, or the enterprise platform 731 requesting the digital human, may monitor the user interaction to score user satisfaction based on the requested/desired context. For example, the requesting platform may request a virtual assistant for a current or future user interaction prioritizing some traits or features for the virtual assistant. A banking website may prioritize a virtual assistant whose appearance, attire, voice, diction, word choice and language, mannerisms, facial and hand gestures, and the like, conveys trustworthiness. If the requesting platform 731 has requested the digital human with a primary attribute of trustworthiness, then it or the digital human platform 501, or the user device 513 or a combination of two or more of the foregoing, may monitor for user satisfaction with the interaction by performing an analysis (e.g., clickthrough rates, length of interaction, repeated user interface input, conversation semantics, user voice and gestures, user body language, etc.). In particular, the requesting platform 731, the digital human platform 501, the user device 513, or a combination of two or more of the foregoing, may monitor for user satisfaction with the conversation with the digital human with respect to the desired attribute(s) of trustworthiness. Indications of user satisfaction with respect to the desired attribute(s) of trustworthiness may include, in addition to the foregoing, how long the user takes to share personal information (e.g., in the case of a banking website, ATM card information or credit card information). Alternatively, the requesting platform 731 and/or the user device 513 may provide the digital human platform 501 with the interaction session data in real-time for analysis (e.g., by streaming the user's camera/virtual camera and the digital human).

In some embodiments, if the user interaction indicates that satisfaction falls below a threshold on trustworthiness (or on one or more other relevant desired attributes), then the requesting platform may in real time request either to replace the digital human with another virtual assistant or to transfer to a human agent, such as to a chat session or to a human operator. Biometric data captured while the user engaged in the user interaction or thereafter may be captured, including a facial expression, a gesture, a vocal sound, and/or the like, and used to determine user satisfaction. The digital human platform, on receiving a request to replace the digital human, or on detecting via analysis that the interaction is falling below a threshold, may use a technique such as reinforcement learning to create and deliver a new digital human, while also adding the current interaction into the training data. The captured biometric data may be stored in association with metadata for the prior assistant. In this manner, real-time intervention may be performed to improve the user's experience.

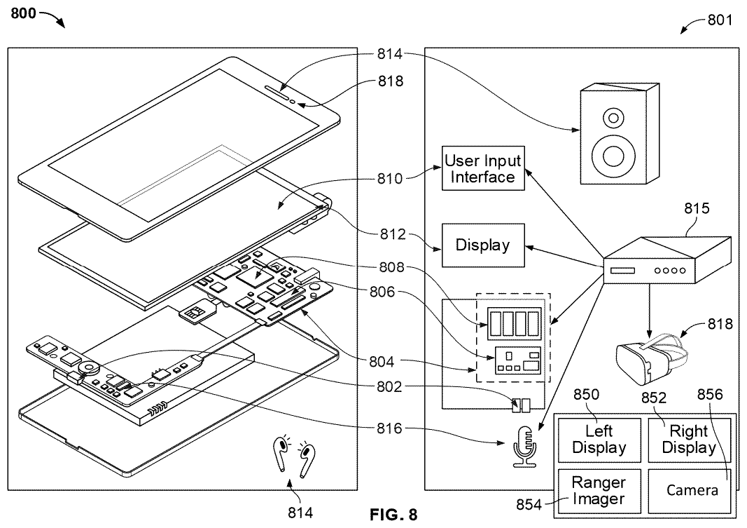

FIG. 8 illustrates an example of generalized embodiments of illustrative user equipment devices 800 and 801, which may correspond to, e.g., computing devices 501, 531, 513. For example, user equipment device 800 may be a smartphone device, a tablet, a virtual reality or augmented reality device, or any other suitable device capable of processing video data. In another example, user equipment device 801 may be a user television equipment system or device. User equipment device 801 may include set-top box 815. Set-top box 815 may be communicatively connected to microphone 816, audio output equipment (e.g., speaker or headphones 814), and display 812. In some embodiments, display 812 may be a television display or a computer display. In some embodiments, set-top box 815 may be communicatively connected to user input interface 810. In some embodiments, user input interface 810 may be a remote-control device. Set-top box 815 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path.

Each one of user equipment device 800 and user equipment device 801 may receive content and data via input/output (I/O) path 802 that may comprise I/O circuitry (e.g., network card, or wireless transceiver). I/O path 802 may provide content (e.g., broadcast programming, on-demand programming, Internet content, content available over a local area network (LAN) or wide area network (WAN), and/or other content) and data to control circuitry 804, which may comprise processing circuitry 806 and storage 808. Control circuitry 804 may be used to send and receive commands, requests, and other suitable data using I/O path 802, which may comprise I/O circuitry. I/O path 802 may connect control circuitry 804 (and specifically processing circuitry 806) to one or more communications paths (described below). I/O functions may be provided by one or more of these communications paths, but are shown as a single path in FIG. 8 to avoid overcomplicating the drawing. For example, set-top box 815 may be replaced by, or complemented by, a personal computer (e.g., a notebook, a laptop, a desktop), a smartphone, a tablet, a network-based server hosting a user-accessible client device, a non-user-owned device, any other suitable device, or any combination thereof.

Control circuitry 804 may be based on any suitable control circuitry such as processing circuitry 806. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i9 processors) or multiple different processors (e.g., an Intel Core i9 processor and an Intel Core i7 processor). In some embodiments, control circuitry 804 executes instructions for the AR application stored in memory (e.g., storage 808). Specifically, control circuitry 804 may be instructed by the AR application to perform the functions discussed above and below. In some implementations, processing or actions performed by control circuitry 804 may be based on instructions received from the AR application.

In client/server-based embodiments, control circuitry 804 may include communications circuitry suitable for communicating with a server or other networks or servers. The AR application may be a stand-alone application implemented on a device or a server. The AR application may be implemented as software or a set of executable instructions. The instructions for performing any of the embodiments discussed herein of the AR application may be encoded on non-transitory computer-readable media (e.g., a hard drive, random-access memory on a DRAM integrated circuit, read-only memory on a BLU-RAY disk, etc.). For example, in FIG. 8, the instructions may be stored in storage 808, and executed by control circuitry 804 of a device 800.

In some embodiments, the AR application may be a client/server application where only the client application resides on device 800 (e.g., device 104), and a server application resides on an external server. For example, the AR application may be implemented partially as a client application on control circuitry 804 of device 800 and partially on server 604 as a server application running on control circuitry 611. Server 604 may be a part of a local area network with one or more of devices 800 or may be part of a cloud computing environment accessed via the internet. In a cloud computing environment, various types of computing services for performing searches on the internet or informational databases, providing AR generation, providing storage (e.g., for a database) or parsing data (e.g., using machine learning algorithms described above and below) are provided by a collection of network-accessible computing and storage resources, referred to as “the cloud.” Device 513 may be a cloud client that relies on the cloud computing capabilities from server 501, 531 to determine whether processing (e.g., at least a portion of virtual background processing and/or at least a portion of other processing tasks) should be offloaded from the mobile device, and facilitate such offloading. When executed by control circuitry of server, the AR application may instruct control circuitry to perform processing tasks for the client device and facilitate the AR generation.

Control circuitry 804 may include communications circuitry suitable for communicating with a server, edge computing systems and devices, a table or database server, or other networks or servers The instructions for carrying out the above mentioned functionality may be stored on a server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 6). In addition, communications circuitry may include circuitry that enables peer-to-peer communication of user equipment devices, or communication of user equipment devices in locations remote from each other (described in more detail below).

Memory may be an electronic storage device provided as storage 808 that is part of control circuitry 804. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 808 may be used to store various types of content described herein as well as AR application data described above (e.g., database 420). Nonvolatile memory may also be used (e.g., to launch a boot-up routine and other instructions). Cloud-based storage may be used to supplement storage 808 or instead of storage 808.

Control circuitry 804 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 804 may also include scaler circuitry for upconverting and downconverting content into the preferred output format of user equipment 800. Control circuitry 804 may also include digital-to-analog converter circuitry and analog-to-digital converter circuitry for converting between digital and analog signals. The tuning and encoding circuitry may be used by user equipment device 800, 801 to receive and to display, to play, or to record content. The tuning and encoding circuitry may also be used to receive video AR generation data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 808 is provided as a separate device from user equipment device 800, the tuning and encoding circuitry (including multiple tuners) may be associated with storage 808.

Control circuitry 804 may receive instruction from a user by way of user input interface 810. User input interface 810 may be any suitable user interface, such as a remote control, mouse, trackball, keypad, keyboard, touch screen, touchpad, stylus input, joystick, voice recognition interface, or other user input interfaces. Display 812 may be provided as a stand-alone device or integrated with other elements of each one of user equipment device 800 and user equipment device 801. For example, display 812 may be a touchscreen or touch-sensitive display. In such circumstances, user input interface 810 may be integrated with or combined with display 812. In some embodiments, user input interface 810 includes a remote-control device having one or more microphones, buttons, keypads, any other components configured to receive user input or combinations thereof. For example, user input interface 810 may include a handheld remote-control device having an alphanumeric keypad and option buttons. In a further example, user input interface 810 may include a handheld remote-control device having a microphone and control circuitry configured to receive and identify voice commands and transmit information to set-top box 815.

Audio output equipment 814 may be integrated with or combined with display 812. Display 812 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 812. Audio output equipment 814 may be provided as integrated with other elements of each one of device 800 and equipment 801 or may be stand-alone units. An audio component of videos and other content displayed on display 812 may be played through speakers (or headphones) of audio output equipment 814. In some embodiments, audio may be distributed to a receiver (not shown), which processes and outputs the audio via speakers of audio output equipment 814. In some embodiments, for example, control circuitry 804 is configured to provide audio cues to a user, or other audio feedback to a user, using speakers of audio output equipment 814. There may be a separate microphone 816 or audio output equipment 814 may include a microphone configured to receive audio input such as voice commands or speech. For example, a user may speak letters or words that are received by the microphone and converted to text by control circuitry 804. In a further example, a user may voice commands that are received by a microphone and recognized by control circuitry 804. AR display device 818 may be any suitable AR display device (e.g., an integrated head mountain display or AR display device connected to a system 800). In some embodiments all elements of system 800 may be places into housing of the AR display device 818. In some embodiments, AR display device 818 comprises a camera (or a camera array) 856. Video cameras 856 may be integrated with the equipment or externally connected. One or more of cameras 856 may be a digital camera comprising a charge-coupled device (CCD) and/or a complementary metal-oxide semiconductor (CMOS) image sensor. One or more of cameras 856 may be an analog camera that converts to digital images via a video card. In some embodiments, one or more of cameras 856 may be dirtied at outside physical environment (e.g., two cameras may be pointed out to capture to parallax views of the physical environment). In some embodiments, one or more of cameras 856 may be pointed at user's eyes to measure their rotation to be used as biometric sensors. In some embodiments, AR display device 818 may comprise other biometric sensor or sensors to measure eye rotation (e.g., electrodes to measure eye muscle contractions). AR display device 818 may also comprise range image 854 (e.g., LASER or LIDAR) for computing distance of devices by bouncing the light of the objects and measuring delay in return (e.g., using cameras 856). In some embodiments, AR display device 818 comprises left display 850, right display 850 (or both) for generating VST images, or see-through AR images.

The AR application may be implemented using any suitable architecture. For example, it may be a stand-alone application wholly-implemented on each one of user equipment device 800 and user equipment device 801. In such an approach, instructions of the application may be stored locally (e.g., in storage 808), and data for use by the application is downloaded on a periodic basis (e.g., from an out-of-band feed, from an Internet resource, or using another suitable approach). Control circuitry 804 may retrieve instructions of the application from storage 808 and process the instructions to provide AR generation functionality and preform any of the actions discussed herein. Based on the processed instructions, control circuitry 804 may determine what action to perform when input is received from user input interface 810. For example, movement of a cursor on a display up/down may be indicated by the processed instructions when user input interface 810 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

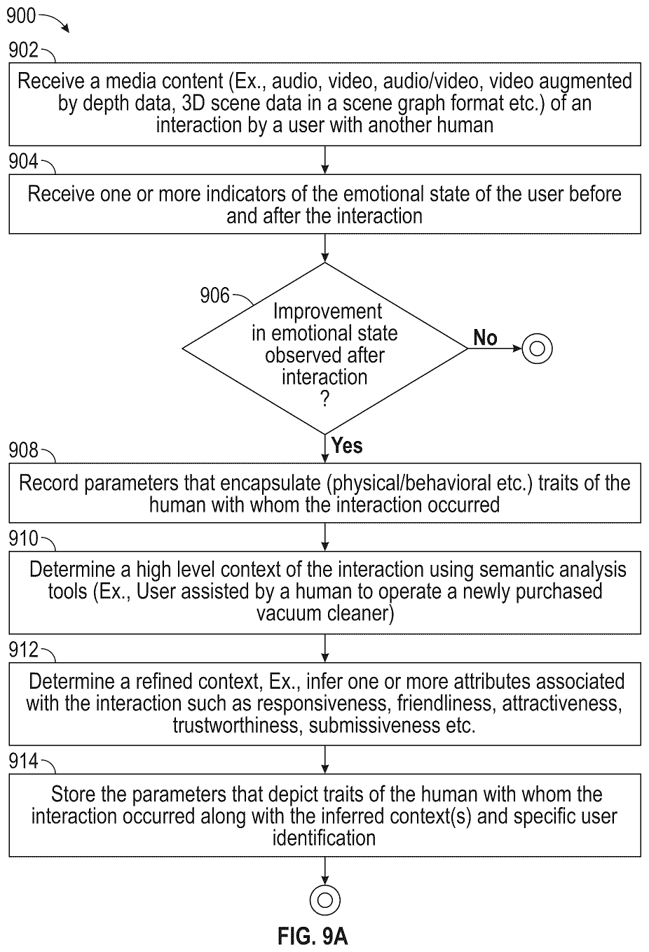

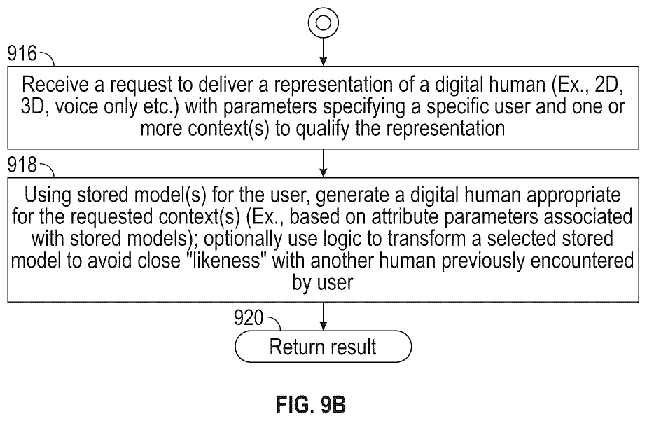

FIGS. 9A and 9B contain a flowchart showing an example of a process 900 for identifying features of a previous human interaction or virtual agent interaction and generating a virtual assistant accordingly. The process 900 may be implemented, in whole or in part, by the systems shown in FIG. 8. One or more actions of the process 900 may be incorporated into or combined with one or more actions of any other process or embodiments described herein. The process 900 may be saved to a memory or storage (e.g., the storage of the system shown in FIG. 8) as one or more instructions or routines, which may be executed by any suitable device or system having access to the memory or storage to implement the process 900.

As shown at 902, the system may receive media content regarding a user interaction with another human or with a virtual digital human. In some embodiments, such information may be stored and searched for later, for example, when a request for generating the virtual human is received or when a likelihood is determined for imminent or future receipt of such a request.

At 904, one or more indicators of the satisfaction level of the user in the prior interaction may be determined based on various indicators. At 906, it is determined whether the satisfaction level of the user meets a threshold. If not, then the prior user interaction may not be used, for example, based on indications of the emotional state of the user during or following the prior user interaction. If it does meet the satisfaction threshold, then at 908 parameters, such as physical behavioral and other features of the prior user interaction may be recorded. At 910, the system may determine a high-level context, such as setting or semantic context of the prior user interaction. At 912, the system may determine, additional features, such as personality traits, and other attributes of the human or the digital human of the prior interaction. Such attributes may include friendliness, attractiveness, trustworthiness, submissiveness, and the like. At 914, features of the human or virtual human of the prior interaction are, inferred and stored.

As shown at 916 of FIG. 9B, when a request to provide a virtual assistant or other type of digital human is received, then features of the previously stored human or features of the previously stored digital human may be retrieved to generate the virtual assistant. At 918, using the stored model, the digital human may be generated or selected. Additional features may then be used to further personalize the digital virtual assistant. Additional logic may be utilized to transform the selected or generated model to avoid too close of a likeness with another human of the previous user interaction. At 920, the result is returned.

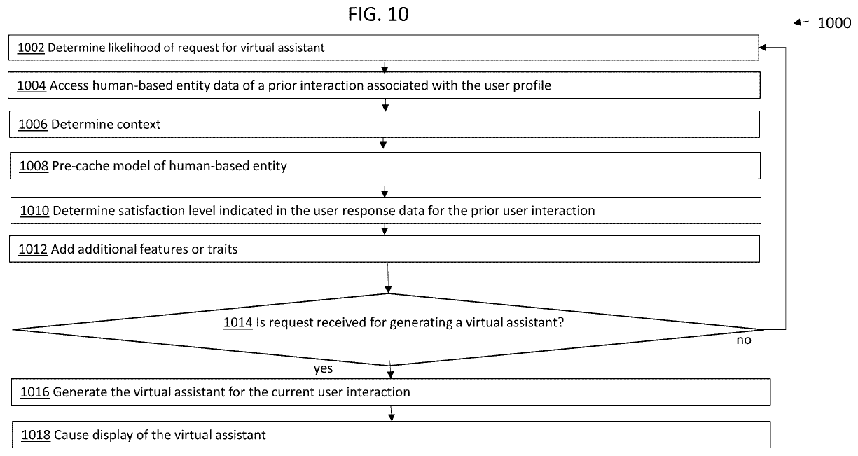

FIG. 10 is a flowchart showing an example of a process 1000 for determining an airborne object's shadow on the surface. The process 1000 may be implemented, in whole or in part, by the computing systems shown in FIG. 8. One or more actions of the process 1000 may be incorporated into or combined with one or more actions of any other process or embodiments described herein. The process 1000 may be saved to a memory or storage (e.g., the storage of the system shown in FIG. 8) as one or more instructions or routines, which may be executed by any suitable device or system having access to the memory or storage to implement the process 1000.

As shown in FIG. 10, at 1002, the system may determine a likelihood that a request for a virtual assistant may be received. As discussed, while referred to sometimes as virtual assistant, this may be an avatar or digital human with human-like features of various types serving one or more of a variety of roles. For example, the virtual assistant may appear in a metaverse environment or augmented reality or virtual reality world to guide the user or the user's avatar, or may have the role of being the user's avatar.

At 1004, a human-based entity (e.g., in a prior user interaction with an actual human or in a prior user interaction with a human-like virtual assistant) associated with the user profile may be accessed.

At 1006, the context of the prior user interaction thus identified may be compared with the context of the present user interaction. In an embodiment, if the contexts are different then the assistant model of the prior user interaction may not be used as a template for the virtual assistant to be generated. In an embodiment, if the contexts are different but the content categories are the same (e.g., in both contexts, the user is interacting with a financial institution), then the assistant model of the prior user interaction may be used. In some embodiments, the prior model may be used but modified with other features or traits if the context is different or if the context category is different. In some embodiments, the contexts may be determined and/or compared later or earlier in this process. For example, the context may be determined and further processing with the model associated with the prior user interaction may continue only if the user satisfaction level of the prior interaction meets or exceeds the satisfaction threshold. Or, the pre-caching may be performed and further processing with the model associated with the prior user interaction may continue only if the contexts match. Similarly, the pre-caching may be performed only if the context categories match. By way of further example, the user satisfaction level may be determined and further processing with the model associated with the prior user interaction may continue only if the context of the prior interaction matches the current context. Or, the user satisfaction level may be determined and further processing with the model associated with the prior user interaction may continue only if the context categories match.

At 1008, the prior model may be pre-cached. Such pre-caching may include all features and properties of the prior model. In some embodiments, only a template or scheme of the prior model may be pre-cached. For example, identifying and loading additional features of the prior model may be unnecessary if the satisfaction level of the user associated with the prior assistant does not meet or exceed the satisfaction threshold.

At 1010, the system may eliminate the human-based entity from further consideration if it determines that user response data for the prior user interaction indicates a user satisfaction level that fails to meet or to exceed a satisfaction threshold. For example, the system may determine an average (e.g., arithmetic mean or median) level of satisfaction for comparable user interactions based on the feedback of users or from other sources, and based on this it may decide whether the user satisfaction level of the present user with this prior user interaction had met or exceeded the average satisfaction level. In some embodiments, the checking of the user satisfaction level for the prior user transaction may be performed prior to pre-caching of the prior model. pre-cache model of human-based entity.

At 1012, additional features or traits may be determined and added or substituted in to replace other features or traits.

At 1014, the system may determine whether a request for generating a virtual assistant for a virtual assistant for the current user interaction has been received. If not, then the system may return to 1002.

If yes, then the system may proceed to 1016 and generate the virtual assistant for the current user interaction. In an implementation, additional features or traits may be determined and added or substituted in to replace other features or traits at this time, in addition to, or instead of at 1012.

At 1018, the virtual assistant for the current user interaction may be caused to be displayed. For example, the user device 513 of FIG. 5 may display the virtual assistant as an overlay or as part of what is rendered by a requesting platform, or the user device 513 may display the virtual assistant separately from other graphical user interface elements.

In some embodiments, an AR application may be used in the current user interaction, which may be via a client/server-based application. Data for use by a thick or thin client implemented on each one of user equipment device 800 and user equipment device 801 may be retrieved on demand by issuing requests to a server remote from each one of user equipment device 800 and user equipment device 801. For example, the remote server may store the instructions for the application in a storage device. The remote server may process the stored instructions using circuitry (e.g., control circuitry 804) and generate the displays discussed above and below. The client device may receive the displays generated by the remote server and may display the content of the displays locally on device 800. In this way, the processing of the instructions may be performed remotely by the server while the resulting displays (e.g., that may include text, a keyboard, or other visuals) are provided locally on device 800. Device 800 may receive inputs from the user via input interface 810 and transmit those inputs to the remote server for processing and generating the corresponding displays. For example, device 800 may transmit a communication to the remote server indicating that an up/down button was selected via input interface 810. The remote server may process instructions in accordance with that input and generate a display of the application corresponding to the input (e.g., a display that moves a cursor up/down). The generated display is then transmitted to device 800 for presentation to the user.

In some embodiments, the AR application may be downloaded and interpreted or otherwise run by an interpreter or virtual machine (run by control circuitry 804). In some embodiments, the AR application may be encoded in the ETV Binary Interchange Format (EBIF), received by control circuitry 804 as part of a suitable feed, and interpreted by a user agent running on control circuitry 804. For example, the AR application may be an EBIF application. In some embodiments, the AR application may be defined by a series of JAVA-based files that are received and run by a local virtual machine or other suitable middleware executed by control circuitry 804. In some of such embodiments (e.g., those employing MPEG-2 or other digital media encoding schemes), the AR application may be, for example, encoded and transmitted in an MPEG-2 object carousel with the MPEG audio and video packets of a program.

One or more actions of the methods 900-1000 may be incorporated into or combined with one or more actions of any other process or embodiments described herein. These and other methods described herein, or portions thereof, may be saved to a memory or storage (e.g., of the systems shown in FIG. 8) or locally as one or more instructions or routines, which may be executed by any suitable device or system having access to the memory or storage to implement these methods.

The term “and/or,” may be understood to mean “either or both” of the elements thus indicated. Additional elements may optionally be present unless excluded by the context. Terms such as “first,” “second,” “third” in the claims referring to a structure, module or step should not necessarily be construed to mean precedence or temporal order but are generally intended to distinguish between claim elements.

The above-described embodiments are intended to be examples only. Components or processes described as separate may be combined or combined in ways other than as described, and components or processes described as being together or as integrated may be provided separately. Steps or processes described as being performed in a particular order may be re-ordered or recombined.

The interfaces, processes, and analysis described may, in some embodiments, be performed by an application. The application may be loaded directly onto each device of any of the systems described or may be stored in a remote server or any memory and processing circuitry accessible to each device in the system. The generation of interfaces and analysis there-behind may be performed at a receiving device, a sending device, or some device or processor therebetween.

Any use of a phrase such as “in some embodiments” or the like with reference to a feature is not intended to link the feature to another feature described using the same or a similar phrase. Any and all embodiments disclosed herein are combinable or separately practiced as appropriate. Absence of the phrase “in some embodiments” does not imply that the feature is necessary. Inclusion of the phrase “in some embodiments” does not imply that the feature is not applicable to other embodiments or even all embodiments.

Features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time.

It should also be noted that the systems and/or methods described above may be applied to, or used in accordance with, other systems and/or methods. In various embodiments, additional elements may be included, some elements may be removed, and/or elements may be arranged differently from what is shown. Alterations, modifications and variations can be effected to the particular embodiments by those of skill in the art without departing from the scope of the present application, which is defined solely by the claims appended hereto.

Throughout the specification, the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

1. A computer-implemented method comprising:
determining, based on a current online interaction using a first mode and associated with a user profile, a likelihood of a request for a virtual assistant entity with a human-like appearance;
accessing user activity data associated with the user profile, wherein the user activity data comprises a prior online interaction with a first online assistant entity with a human-based appearance;
pre-caching data for the virtual assistant entity with the human-like appearance with at least the one identified feature of the prior online assistant entity with the human-based appearance;
determining that user response data for the prior online interaction indicates a user satisfaction level that exceeds a predetermined satisfaction threshold;
identifying at least one feature of the prior online assistant entity with the human-based appearance based at least in part on the determining that the user satisfaction level exceeds the predetermined satisfaction threshold;
receiving, based on the current online interaction associated with the user profile, a request for the virtual assistant entity with the human-like appearance and a current context of the current online interaction;
transitioning from the first mode of the current user interaction by generating an appearance of the virtual assistant entity with the human-like appearance, wherein the virtual assistant entity with the human-like appearance is based at least in part on the data for the pre-cached virtual entity with the human-like appearance and the identified at least one feature of the first online assistant entity and a matching of the current context of the current online interaction with a prior context of the prior online interaction; and
causing display of the generated virtual assistant entity.

2. The method of claim 1, wherein the prior online interaction comprises display of an image or video of a human agent responding via a network connection.

3. The method of claim 1, wherein the user satisfaction level with the prior online interaction is determined based at least in part on a length of the prior online interaction, a user-entered graphical user interface command received during the prior online interaction,, or a user rating received in response to the prior online interaction.

4. The method of claim 1, wherein the user satisfaction level with the prior online interaction is determined based at least in part on user eye movement during the prior online interaction, user facial expression during the prior online interaction, user pupil dilation during the prior online user interaction, user verbal tone during the prior online user interaction, or user sentiment during the prior online user interaction.

5. The method of claim 1, wherein the feature of the prior online assistant entity with the human-based appearance comprises facial feature points, hair type, color of hair, color of skin, color of eyes, shape of eyes, shape of mouth, or one or more languages used.

6. The method of claim 1, wherein the matching of the current context of the current online interaction with the prior context of the prior online interaction comprises:
determining a first context category of the first context of the prior online user interaction;
and determining a second context category of the current context of the current online interaction; and
determining that the first context category is a same as the second context category.

7. The method of claim 1, further comprising:
identifying a personality trait of the first online assistant entity with a human-based appearance; and
generating the virtual assistant entity with the human-like appearance based at least in part on the identified personality trait of the first online assistant entity with the human-based appearance.

8. The method of claim 1, wherein the generating of the appearance of the virtual assistant entity with the human-like appearance comprises:
adapting a stored digital human model, wherein the adapting is based at least in part on the identified at least one feature of the first online assistant entity with the human-based appearance.

9. The method of claim 1, further comprising:
determining that second user response data for the online interaction indicate a second user satisfaction level that exceeds the predetermined satisfaction threshold;
identifying a second feature of the virtual assistant entity with the human-like appearance based at least in part on the determining that the second user response data for the virtual assistant interaction indicates that the second user satisfaction level exceeds the predetermined satisfaction threshold;
receiving a second request for a second virtual assistant interaction associated with the user profile;
generating an appearance of a second virtual assistant entity with a human-like appearance based at least in part on the identified second feature of the virtual assistant entity with the human-like appearance; and
causing display of the appearance of the second virtual assistant entity with the human-like appearance generated for the request for the second virtual assistant interaction.

10. The method of claim 9, wherein the generating the appearance of the second virtual assistant entity based at least in part on the identified second feature of the virtual assistant entity further comprises:
generating the appearance of the second virtual assistant entity based at least in part on the identified feature of the virtual assistant entity.

11. The method of claim 1, further comprising:
identifying a second feature of the first online assistant entity with the human-based appearance;
wherein the generating the appearance of the virtual assistant entity with a human-like appearance is based at least in part on the identified second feature;
identifying a third feature of the virtual assistant entity with the human-like appearance based at least in part on determining that second response data for virtual assistant interaction indicates that a second user satisfaction level exceeds the predetermined satisfaction threshold;
determining that the second user satisfaction level exceeds the user satisfaction level indicated by the user response data for the first online interaction;
receiving a request for a second virtual assistant interaction associated with the user profile;
based at least in part on the determining that the second user satisfaction level exceeds the user satisfaction level indicated by the user response data for the first online interaction, generating an appearance of a second virtual assistant entity with a human-like appearance by replacing the second feature of the first online assistant entity with the identified third feature of the virtual assistant entity.

12. The method of claim 1, wherein the request for the virtual assistant entity with the human-like appearance is triggered based on content of first mode in the current online interaction, and wherein the first mode comprises text support.

13. A system comprising:
a memory; and
control circuitry configured to:
determine, based on a current online interaction using a first mode and associated with a user profile, a likelihood of a request for a virtual assistant entity with a human-like appearance;
access user activity data associated with the user profile, wherein the user activity data comprises a prior online interaction with a first online assistant entity with a human-based appearance;
pre-caching data in the memory for the virtual assistant entity with the human-like appearance with at least the one identified feature of the prior online assistant entity with the human-based appearance;
determine that user response data for the prior online interaction indicates a user satisfaction level that exceeds a predetermined satisfaction threshold;
identify at least one feature of the prior online assistant entity with the human-based appearance based at least in part on the determining that the user satisfaction level exceeds the predetermined satisfaction threshold;
receive, based on the current online interaction associated with the user profile, a request for the virtual assistant entity with the human-like appearance and a current context of the current online interaction;
transition from the first mode of the current user interaction by generating an appearance of the virtual assistant entity with the human-like appearance, wherein the virtual assistant entity with the human-like appearance is based at least in part on the data for the pre-cached virtual entity with the human-like appearance and the identified at least one feature of the first online assistant entity and a matching of the current context of the current online interaction with a prior context of the prior online interaction; and
cause display of the generated virtual assistant entity.

14. The system of claim 13, wherein the prior online interaction comprises display of an image or video of a human agent responding via a network connection.

15. The system of claim 13, wherein the user satisfaction level with the prior online interaction is determined based at least in part on a length of the prior online interaction, a user-entered graphical user interface command received during the prior online interaction,, or a user rating received in response to the prior online interaction.

16. The system of claim 13, wherein the user satisfaction level with the prior online interaction is determined based at least in part on user eye movement during the prior online interaction, user facial expression during the prior online interaction, user pupil dilation during the prior online user interaction, user verbal tone during the prior online user interaction, or user sentiment during the prior online user interaction.

17. The system of claim 13, wherein the feature of the prior online assistant entity with the human-based appearance comprises facial feature points, hair type, color of hair, color of skin, color of eyes, shape of eyes, shape of mouth, or one or more languages used.

18. The system of claim 13, wherein the matching of the current context of the current online interaction with the prior context of the prior online interaction comprises:
determining a first context category of the first context of the prior online user interaction; and
determining a second context category of the current context of the current online interaction; and
determining that the first context category is a same as the second context category.

19. The system of claim 13, wherein the system is configured to:
identify a personality trait of the first online assistant entity with a human-based appearance; and
generate the virtual assistant entity with the human-like appearance based at least in part on the identified personality trait of the first online assistant entity with the human-based appearance.

20. The system of claim 13, wherein the generating of the appearance of the virtual assistant entity with the human-like appearance comprises:
adapting a stored digital human model, wherein the adapting is based at least in part on the identified at least one feature of the first online assistant entity with the human-based appearance.

21.-60. (canceled)
